(19) United States
(12) Patent Application Publication
(10) Pub. No.: US 2015/0075123 A1
(43) Pub. Date: Mar. 19, 2015

(54) AIR FILTER AND AIR BOX FOR ENGINES

(71) Applicant: S&B Filters, Inc., Fontana, CA (US)

(72) Inventors: Robert B. Carter, Fontana, CA (US); James Y. Matsuda, Fontana, CA (US)

(73) Assignee: S&B Filters, Inc., Fontana, CA (US)

(21) Appl. No.: 14/027,080

(22) Filed: Sep. 13, 2013

(51) Int. Cl. B01D 46/24; B01D 46/00; F02M 35/04

(52) U.S. Cl. CPC B01D 46/2403; F02M 35/046; B01D 46/0001
USPC 55/419; 29/428

(57) ABSTRACT

An engine air filter box has an inlet housing and an outlet housing separated by a base plate with plural openings. Each opening is covered by a filter having a different height selected to fit between the base plate and the inlet housing while increasing air flow through the openings. The filter shape and cap shape can also be varied.

### BACKGROUND

Internal combustion engines use large volumes of air which must be filtered to remove particulates that impede engine performance and damage engine components. In order to increase filter area cylindrical and frusto-conical filters were developed, as were pleated filter elements on such filter shapes, all housed in cylindrical housings. Prior filter designs use deflectors to guide the flow of air into and around the surfaces of cylindrical filters, stacked cylindrical filters of increasing diameter, or frusto-conical filters. But even with the air guides these filters become long as the filter length increases to provide a desired filter area and flow volume, and often times the volume available under the hood does not lend itself to a cylindrical housing for such filters. There is thus a need for an improved method and apparatus to increase the filter area that is available while accommodating a variety of shapes within which the filter elements must fit.

Rather than use conical or cylindrical filters, many current vehicles are designed with air boxes that are located beneath the vehicle's hood and close to the entrance of the engine's air intake manifold. The air boxes contain a filter element, typically a planar filter that extends across the largest dimension of the box in order to maximize filter area. Fitting various engine components underneath the hood often results in air boxes having odd shapes which do not lend themselves readily to an efficient filter design or to a design that provides as much filter area as desired. Also, placing the filter across the middle of the air box may result in non-uniform air flow across the filter if the air inlet is not ideally located, so that various portions of the filter pass more air than other portions and thus clog faster, reduce air flow and impede engine performance and filter efficiency. There is thus a need for an improved method and apparatus for providing air filters for use in such air boxes while allowing greater flexibility in providing a desired filter surface area and flow rate through the filter and through the air box.

### BRIEF SUMMARY

An engine air filter box has an inlet housing and an outlet housing separated by a base plate with plural openings. Each opening is covered by a filter having a different height selected to fit between the base plate and the inlet housing while increasing air flow through the openings. The filter shape and cap shape can also be varied.

An improved air filter is thus provided that includes a plurality of filter elements each formed of an air permeable material. Each filter element has a body portion with an open upper end portion and an open lower end portion with a cap positioned on the filter element open upper end portion to close the open upper end portion. The open lower end portion is connected to a base plate having a plurality of openings therein so each of the plurality of filter elements may be placed over a different one of the plurality of openings in the base plate. The base plate forms one wall of an air box, the shape of which may vary, and preferably forms the base of the air box which may be removably or permanently fastened to the remainder of the air box. The air box has an air inlet on one side of the base plate and an air outlet on the other side of the base plate. The base plate is preferably planar and the wall opposing the air box base may have one or more portions inclined relative to the base plate and/or at different distances from the base plate. The number, location, size, shape and height of each filter element and its cap may be varied, based on the shape of the air box and the distance between the base and opposing wall of the air box, the volume and speed of the air flow through the air box, the drag through the air box, and based on the area of the filter elements operative in the air box. A change in filter thickness is considered to be a change in filter shape, as is the number of pleats or using an un-pleated filter element. The filter elements may thus have diverse shapes, including oval or shapes with combinations of flat and curved sides, with open top portions closed by a cap and open lower end portions.

The filter elements may have a conical-shaped body portion with an open upper end portion and an open lower end portion in which the open upper end portion has a smaller diameter than the diameter of the open lower end portion with a cap positioned in the filter element open upper end portion to close the open upper end portion. The filter elements may be like the conical-shaped body portion but have an air permeable material in a cylindrical shape with an open upper end portion and closed lower end portion of substantially the same diameter. The filter elements may have diverse shapes, including oval or shapes with combinations of flat and curved sides, with open top portions closed by a cap and open lower end portions.

There is also provided an assembly for use with an air filter box having an inlet housing with an air inlet, an outlet housing with an air outlet, and a base plate separating the inlet and outlet housing. The assembly includes a base plate having a plurality of openings extending therethrough. The plate also has an inlet side and an opposing outlet side and a periphery configured to mate with at least one of the inlet housing or outlet housing. The assembly has at least two, tubular air permeable filter elements located on the intake side of the base plate and extending away from that intake side of the base plate. The at least two filter elements each have an open bottom end that is sealingly connected to the base plate with at least a portion of the filter element encircling a different one of said openings associated with the filter element. The at least two of the filter elements also each have an open top extending away from the base plate sufficient to define a height which height is not great enough so the filter element contacts a portion of the air inlet housing during use. Each filter element also has a cap sealingly connected to the open top end of the filter element to close the open top. The at least two filter elements differ from each other in at least one of a filter shape, the filter height, an opening size associated with the filter, and opening shape associated with the filter.

The filter assembly advantageously has from 2-12 filter elements, and more preferably has from 3-8 filter elements and more preferably from 2-6 filter elements. The filter elements may be conical filters of different diameter and height sized to fit within the inlet housing, or may be filters of different size and shape. Advantageously the base plate is sealably connected to the inlet housing, although it may be sealably connected to the outlet housing, and may further be sealably connected between the inlet and outlet housings.

There is also provided a method of manufacturing or assembling an air filter to a base plate where the plate has an air inlet side and an opposing air outlet side. The base plate and air filter are for use in an air box having an inlet housing and an outlet housing. The method includes acquiring a base plate having at least first and second openings extending therethrough and through which air flows during use of the air filter. The method includes the further step of sealably connecting a bottom portion of a first air permeable filter element to the base so as to surround the first openings and sealably connecting a bottom portion of a second air permeable filter element to the base so as to surround the second opening. The first and second filter elements are connected so they extend on the air inlet side of the base plate. The method also includes sealably connecting a first cap to a top portion of the first air filter element and sealably connecting a second cap to a top portion of the second air filter element, with the caps being sealably connected either before or after the bottom portions are sealably connected to the base plate. The first and second filter elements are selected to be different in at least one of a height, diameter, shape and cap shape and further selected so the filter elements fit between the base plate and the inlet housing when the base plate is fastened to the inlet housing for use.

In further variations, the method may also include fastening the base plate to the inlet housing with the filter elements located between the base plate and the inlet housing. The method may further include the step of fastening the base plate to the outlet housing. The filter assembly may include from 2-12 filter elements, and more advantageously has from 3-8 filter elements and preferably has from 2-6 filter elements. One embodiment has four filter elements.

### BRIEF DESCRIPTION OF THE DRAWINGS

These and other features and advantages of the invention will become more apparent in light of the following discussion and drawings, in which like numbers refer to like parts throughout, and in which:

FIG. 1 is a perspective view of an air housing with a partial section therethrough and showing four filter elements;

FIG. 2a is a perspective view of a base plate and filter elements of FIG. 1, with two filters shown in partial section;

FIG. 2b is a partial sectional view showing the juncture of a base plate and filter element and the configuration of the air passage through a base plate, taken from FIG. 2a;

FIG. 2c is a partial sectional view of the base plate and filter element shown in FIG. 2b, but showing a further embodiment of the juncture and air passage;

FIG. 3 is a perspective view of a base plate having eight filter elements connected to the plate;

FIG. 4 is a bottom elevation view of the base plate of FIG. 3;

FIG. 5 is a perspective view of a further embodiment showing four conical filter elements with domed tops on a base plate;

FIG. 6 is a bottom view of the base plate and filter elements of FIG. 5;

FIG. 7 is a sectional view taken along section 7-7 of FIG. 5;

FIG. 8 is a perspective view of a further embodiment showing two elongated filter elements with flat tops on a trapezoidal base plate;

FIG. 9 is a bottom view of the base plate and filter elements of FIG. 8;

FIG. 10 is a sectional view taken along section 10-10 of FIG. 8;

FIG. 11 is a perspective view showing four tapered filter elements having flat sides and flat tops on a four sided base plate;

FIG. 12 is a bottom view of the base plate and filter elements of FIG. 11;

FIG. 13 is a sectional view taken along section 13-13 of FIG. 11;

FIG. 14 is a perspective view showing four tapered filter elements having oval sides on a trapezoidal base plate;

FIG. 15 is a bottom view of the base plate and filter elements of FIG. 14;

FIG. 16 is a sectional view taken along section 16-16 of FIG. 14;

FIG. 17 is a perspective view of a base plate with curved and straight sides having four conical filter elements with domed tops;

FIG. 18 is a bottom view of the base plate and filter elements of FIG. 17;

FIG. 19 is a sectional view taken along section 19-19 of FIG. 17;

FIG. 20 is a side view showing of a cap for a filter element having a flat top;

FIG. 21 is a top view of the cap of FIG. 20 having a round periphery;

FIG. 22 is a top view of the cap of FIG. 20 having a square periphery with rounded corners;

FIG. 23 is a side view of a cap having a curved top;

FIG. 24 is a top view of the cap of FIG. 23 having a circular periphery;

FIG. 25 is a top view of the cap of FIG. 23 having a square periphery with rounded corners;

FIG. 26 is a side view of a conical cap with curved sides;

FIG. 27 is a top view of the cap of FIG. 26;

FIG. 28 is a sectional view showing a filter element with inclined walls and the cap of FIG. 28 mounted on an inwardly extending conical support with straight sides;

FIG. 29 is a sectional view showing a filter element with inclined walls and the cap of FIG. 28 mounted on an inwardly extending conical support with curved sides; and

FIG. 30 is a sectional view through a further embodiment showing one filter element enclosing a plurality of openings in the base plate.

### DETAILED DESCRIPTION

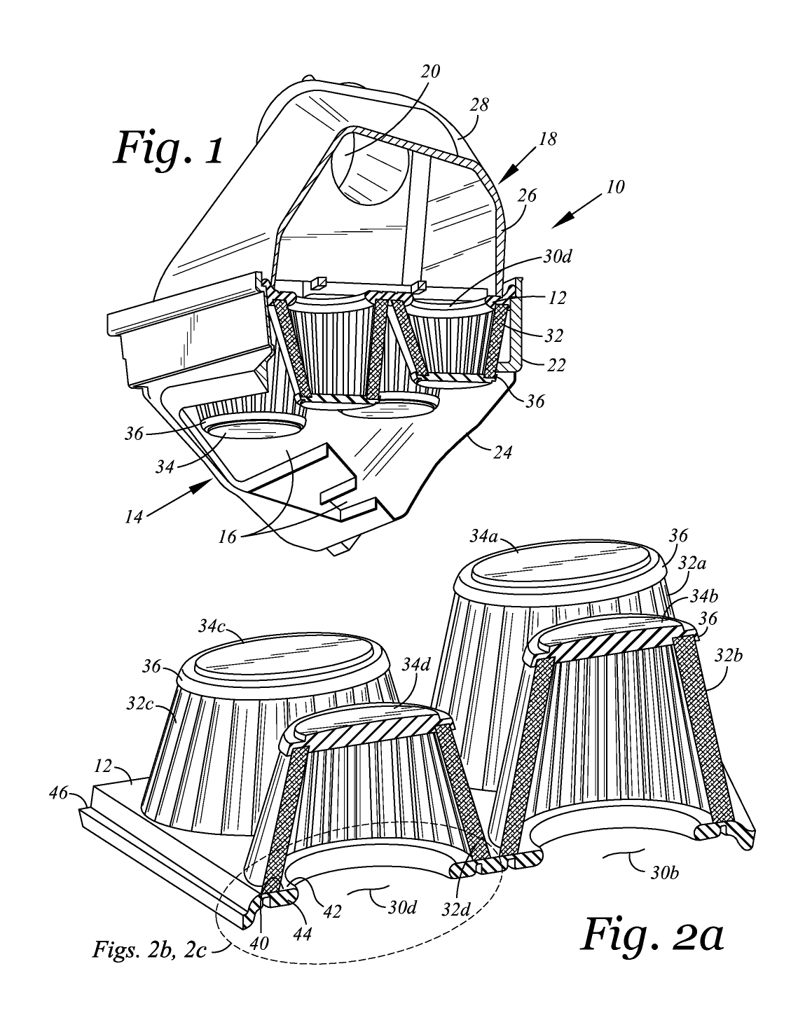

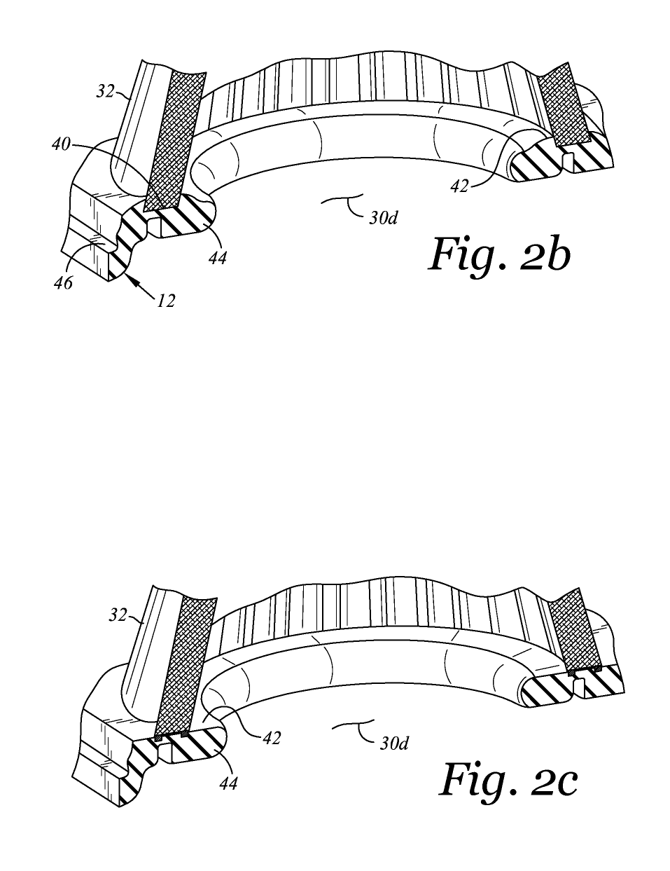

Referring to FIGS. 1 and 2a, an air box 10 has a base plate 12 with an intake housing 14 having an air inlet opening 16 on one side of the base plate 12, and an outlet housing 18 having an air outlet opening 20 on a second, opposing side of the base plate 12. The inlet housing 14 one or more inlet sidewalls 22 and one or more inlet top walls 24 opposite an inlet side of the base plate 12 with the inlet opening 16 located in one of the intake walls 22, 24. The outlet housing 18 has one or more outlet sidewalls 26 and one or more outlet top walls 28 opposite an outlet side of the base plate 12.

The base plate 12 has a plurality of openings 30 extending through the base plate 12 with a plurality of filter elements 32 connected to the base plate and extending into the air intake housing 14. The filter elements 32 are made of an air permeable material and have a tubular shape that is hollow inside with the filter elements having an open top portion and open bottom portion. As used herein tubular includes shapes that do not have parallel walls and specifically includes conical shapes with a hollow interior. The filter elements 32 are typically pleated filter elements with undulating peaks and valleys to increase the filter area, but need not be pleated. A separate cap 34 is connected to the top portion of each filter element 32 to close the open top. The caps 34 may have a lip 36 extending over an exterior side of the top portion of the filter element 32 and may be affixed thereto. The bottom portion of each filter element is connected to the base plate 12 and encircles a different one of the openings 30 in the base plate 12.

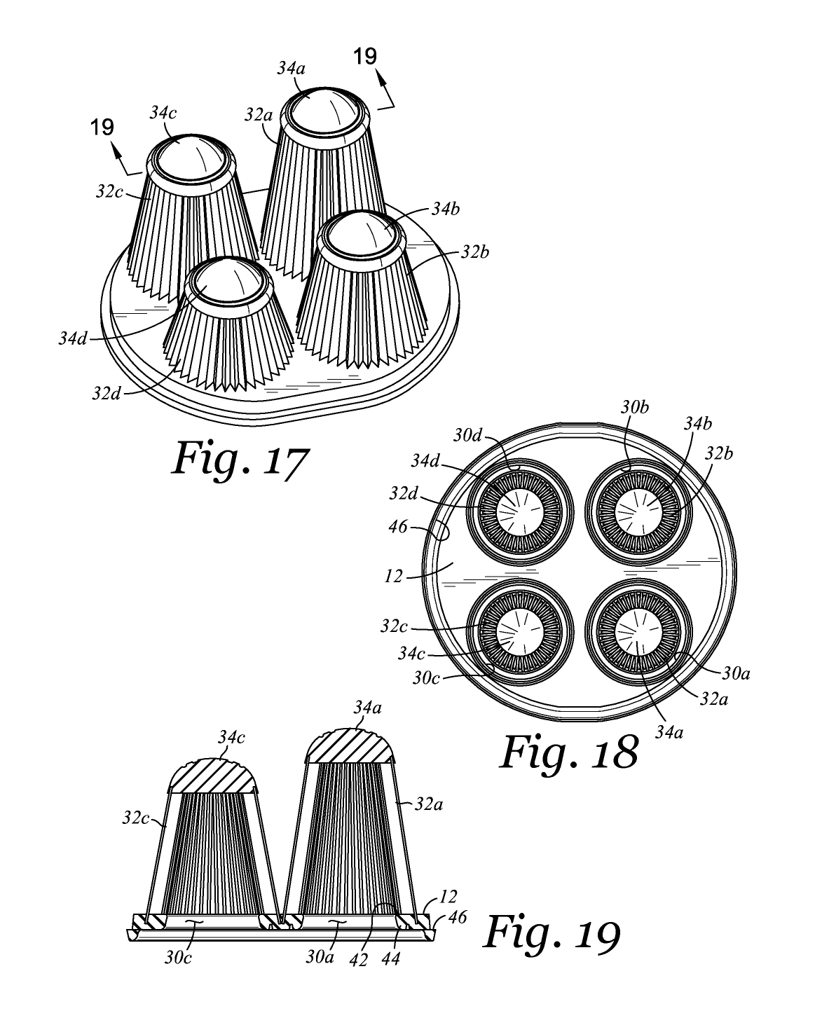

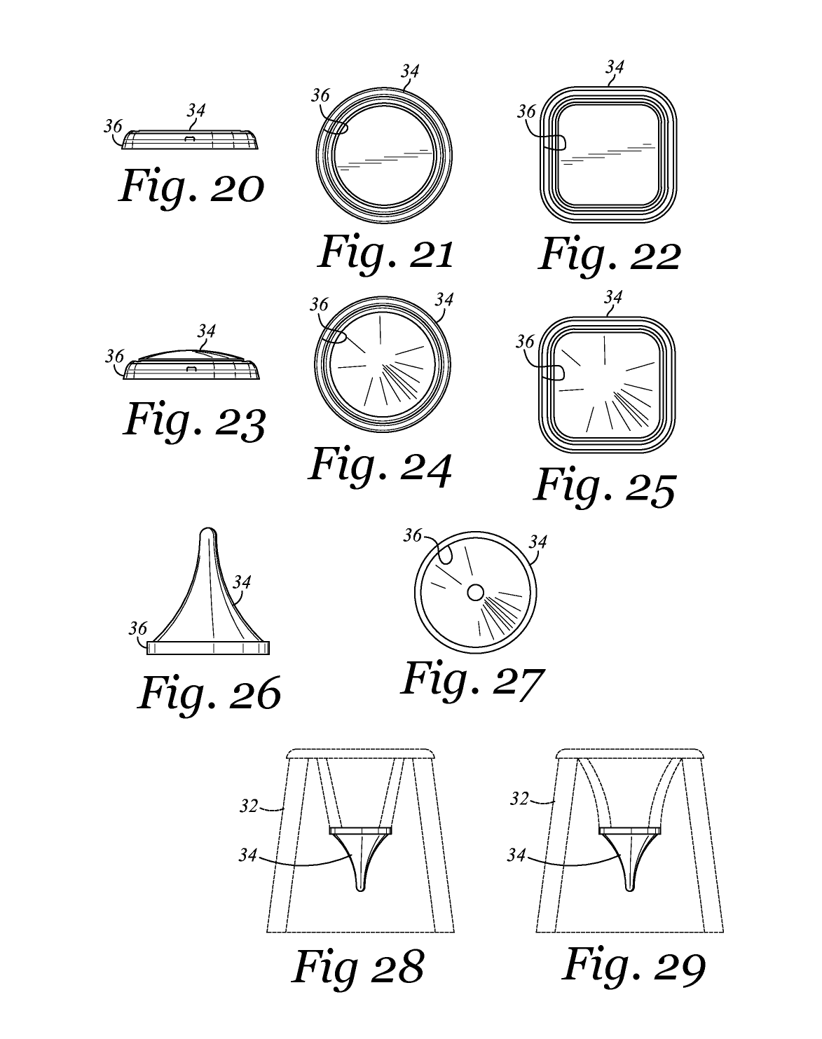

Referring to FIGS. 1 and 3-29, the filter elements 32 may be different size and height and shape, as may the caps 34, and the openings 30 may be of different size and shape. The location, size and shape of openings 30 in base plate 12, the size, height, shape and material of filter elements 32, are varied to achieve a desired flow of air through the filter elements 32 and air box 10. The flow rate in terms of volume per unit time (e.g., liters per minute or cubic feet per minute) and the pressure drop in terms of force per unit area (e.g., psi, N/m²), and the rate at which the filter elements 32 clog over time, may be considered in determining the desired flow of air through the air box 10. The normal air flow is through inlet opening 16 in inlet housing 14, through the exterior sides of filter elements 32 to the inside of filter elements 32, through the base plate openings 30 and then out the outlet opening 20 in outlet housing 18. The filter elements 32 are sealed at the upper end by caps 34 and lip 36 and sealed at the lower end by the connection to the base 12 so that air is forced to flow through the exposed sides of the filter elements 32.

For example, in the embodiment of FIGS. 1-2, the air box 10 (FIG. 1) has an inlet housing 14 has inlet sidewalls 22 that are higher on one side than the other and top walls 24 that are inclined obliquely relative to the base plate 12. Thus, filter element 32a is longer or higher than filter element 32b, which is longer or higher than filter element 32c, which is longer or higher than filter element 32d. The filter elements 32 are cut to different lengths so that the heights of each filter inclined downward from right to left in the orientation shown in FIG. 1 corresponds with the inclination of the inlet top walls 24. The filter elements 32 are conical shaped, or more accurately, frusto-conical in shape having a bottom portion at base plate 12 that is larger in diameter than the top portion at cap 36 and having the top portion typically flat and truncated before the apex at which the sides would normally intersect. As used herein the term conical shall include frusto-conical shapes. The filter element 32a has a larger diameter at base 12 than filter element 32c, which has a larger diameter at base 12 than filter element 32b, which has a larger diameter at base 12 than filter element 32d Likewise, the opening 30a in base plate 12 is larger than opening 30c in base plate 12, which is larger than the opening 30b in base plate 12, which is larger than opening 30c.

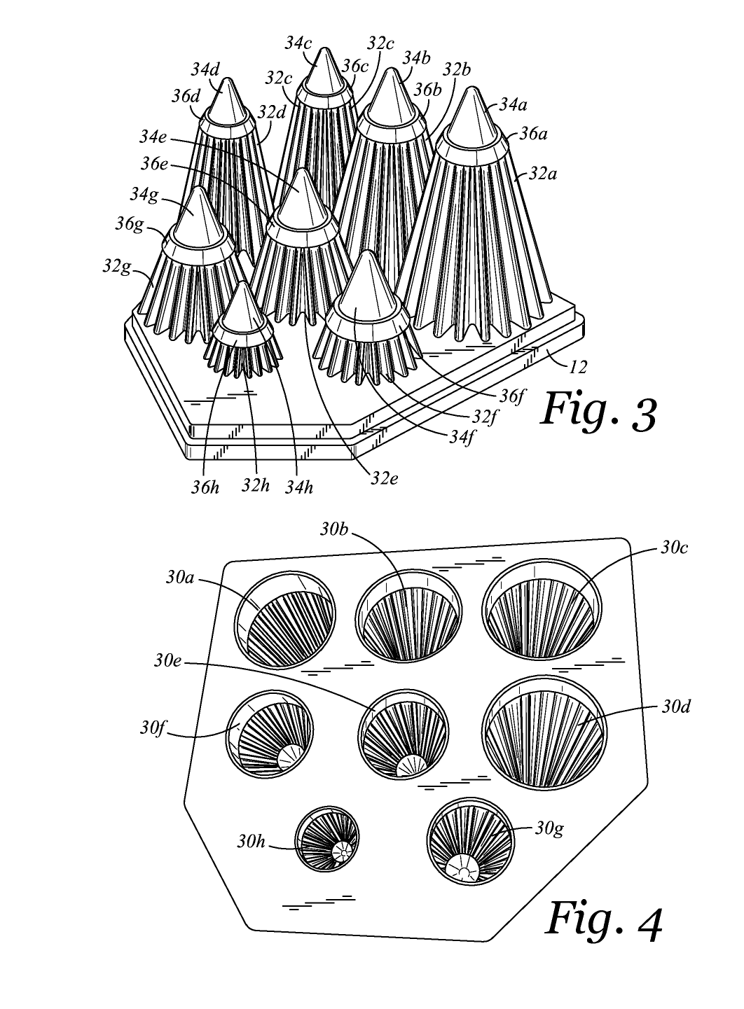

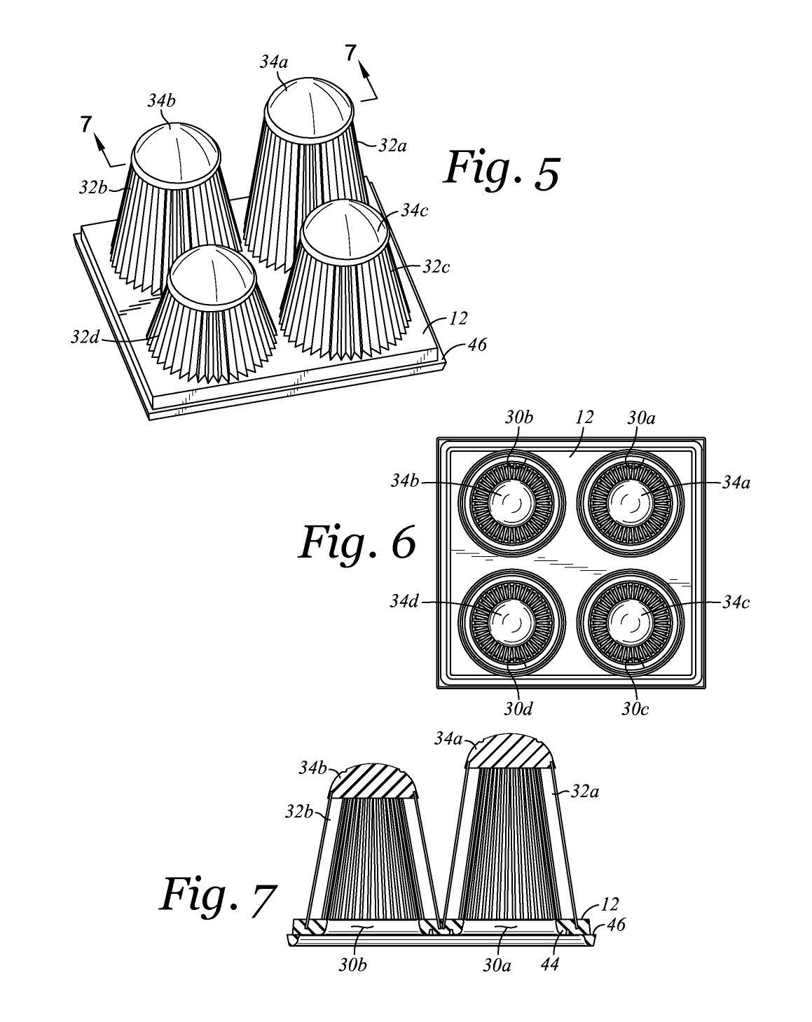

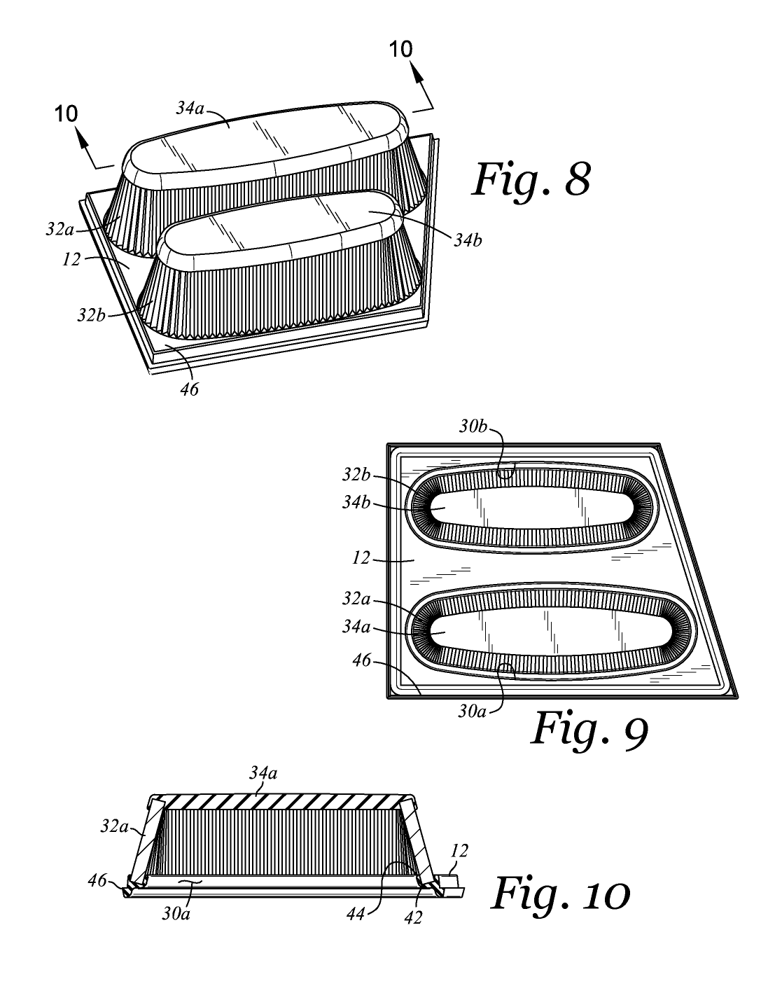

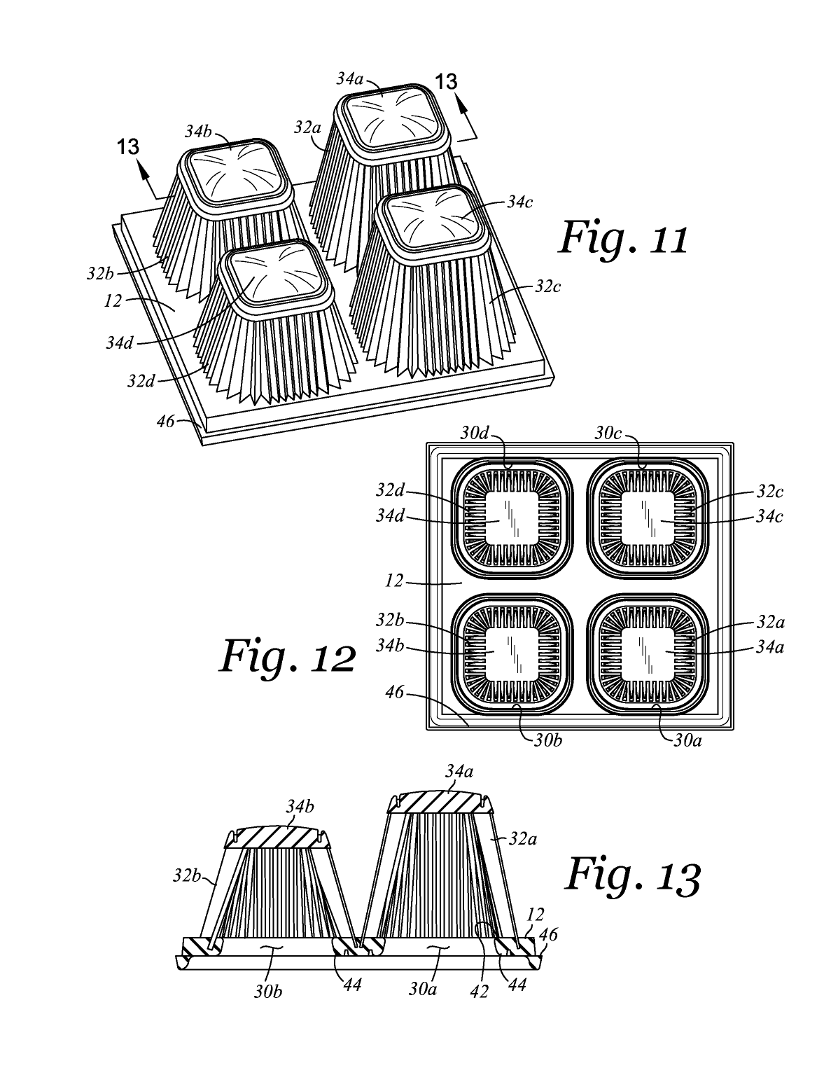

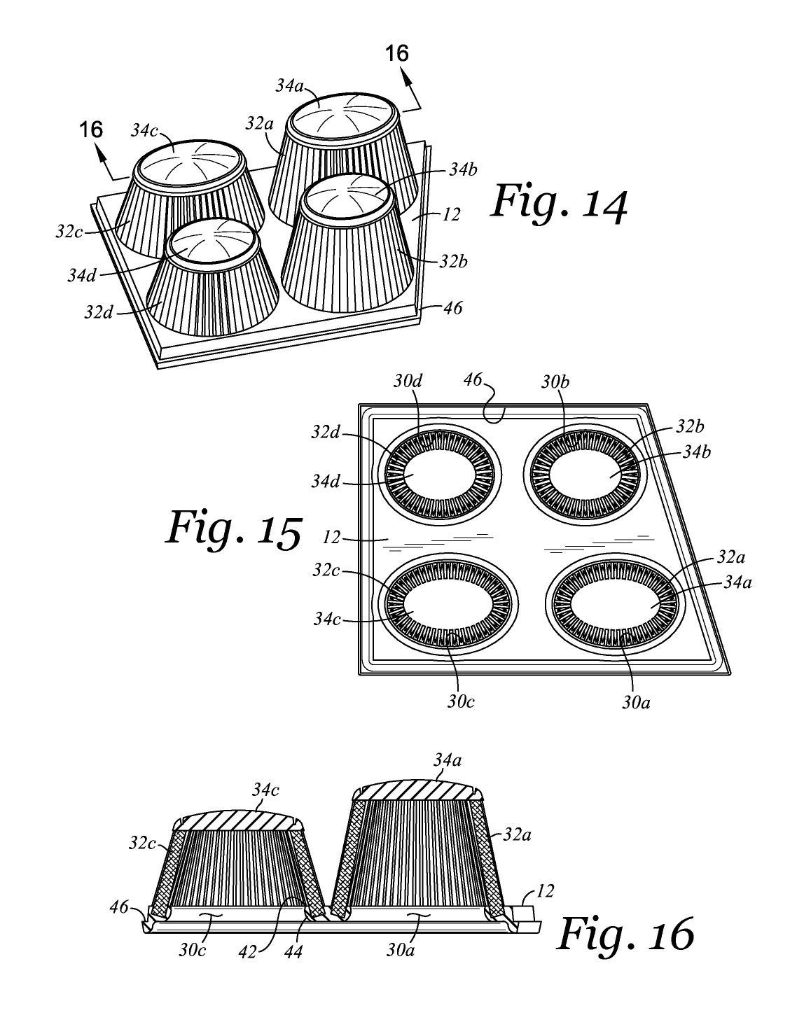

The peripheral shape of the caps 34 will conform to the shape of the filter 32. But the cross-sectional shape of the caps 34 are advantageously selected to achieve a desired air flow through the air box 10. The caps 34 in FIGS. 1 and 2 are flat with a circular periphery. The caps 34 may thus have a flat top as shown in FIGS. 2a, 8-10, and 20-22. The caps 34 may have an exterior shape that is conical with straight sides (FIGS. 3-4) or conical with curved sides as in FIGS. 26-29. The caps 34 may have an exterior shape that is curved or domed to better deflect air flow off the top and along the filter elements as shown as shown in FIGS. 5-7, 11-19 and 23-25. The caps may have a periphery that is circular (FIGS. 2a, 3, 5-7, 17-19, 21, 24, 27), elliptical (FIGS. 14-16), oval (FIGS. 8-10), straight sided (FIGS. 11-13, 22, 25) or of other shapes. The caps 34 may have conical shapes with straight sides (FIGS. 3-4) or have sides curved toward or away from the filter element (FIGS. 26-29). The caps may have shapes that are veined or any other desired shape to improve air flow through the air box 10 Likewise, the inside of the cap 34 may have any desired shape, including flat or curved. U.S. Pat. No. 6,833,023 shows a turbine veined cap and other shapes of caps to alter air flow through filters and any of those shapes may be used. The entire contents of U.S. Pat. No. 6,833,023 are incorporated herein by reference. Further, the shapes of the caps 34 in air box 14 need not all have the shame cross-sectional shape, but may contain any variety of shapes, flat, domed, conical, etc.

As shown in FIGS. 1-2, the filter elements 32 may be conical filters and are preferably symmetric about the longitudinal axis 38 of each filter element. But the filter elements 32 mounted on a plate 12 in air box 10 need not all be of the same shape and may have different shapes, elliptical shapes (FIGS. 14-16), oval shapes (FIGS. 8-10), flat sided shapes including tapered sides with rounded corners as in FIGS. 11-13. While the sides of filter elements 32 are shown as inclined, the sidewalls need not be inclined and may be parallel to each other, forming cylinders and other shapes. But the inclined walls are believed preferable as they facilitate air flow. Thus, the shape of the filter elements 32 will vary and while the caps 34 close off one end of the filter element and thus conform to the shape of the filter element, the exterior shape of the caps 34 and the cross-sectional shape of the caps 34 may will—preferably improve air flow through the filter elements 32 and through the air box 10.

The number of filter elements 32 may also vary. FIGS. 1 and 2a show four conical filter elements 32a-32d. FIGS. 3-4 show eight conical filter elements 32a-32h, with conical caps 34a-34h, having larger diameter, outwardly stepped conical lips 36a-36h. The height or length of filter elements 32a-d is substantially the same and larger than the height or length of filter elements 32e and 32g which are substantially the same. The height or length of filter elements 32e and 32g are greater than that of filter element 32f, which has a height or length of filter element 32f which is greater than that of filter element 32h.

As seen in FIGS. 4, 9 and 15, the diameter or size of the openings 30 in base plate 12 that are associated with each filter element 32 may vary, or they may be the same as in FIGS. 6, 12 and 18. As seen in FIG. 4, the diameter of openings 30a, b, c and d are substantially the same and are larger than the diameter of openings 30e and 30g, which are substantially the same. Opening 30e and 30g are larger than the diameter of openings 30f which is larger than the diameter of opening 30h.

The shape of the air box 10 may vary with the make, model and engine size of a vehicle. The use of different lengths and shapes and sizes of filter elements 32 allows the surface area of the filter to be increased and the flow rate to be increased over that of a planar filter having the area of base plate 12, which represents the normal filter area for a flat panel filter. By using different shapes of filter elements 32 and caps 34 and different locations of filters elements 32 the flow rate and filter area can also be varied. Longer filter elements are suitable for those portions of the air box 10 with greater distances between the base plate 12 and the adjacent inlet top wall, while shorter filter elements are suitable for those portions of the air box 10 with smaller distances between the base plate 12 and the adjacent inlet top wall. The number of filter elements 32 will vary, but between 2-10 filters are believed suitable, with 3-8 filters believed more desirable and 3-5 or 4-6 filters being most desirable. The configuration and arrangement of the various filter elements 32 and caps 34 will vary with the shape of the particular air box.

The location of the filters elements 32 will vary but they are preferably arranged to provide flow through all of the filter elements in proportion to the size of the opening 30 associated with each filter element. For example, if four filter elements are used in an air box 10 and the areas of the opening 30 associated with each of the filters, measured in square inches are 4, 3, 2 and 1, then about 40 percent of the air preferably goes through the filter element associated with the four square inch opening 30, about 30 percent of the air flow preferably goes through the filter element associated with the 3 square inch opening 30, about 20 percent of the air flows through the filter element associated with the 2 square inch opening 30, and about 10 percent of the air flows through the filter element associated with the one square inch opening 30.

The filter elements 32 are preferably arranged on the base 12 so that the area of the openings 30 in base 12 are maximized in order to increase air flow. The openings 30 are also preferably spaced fairly equally about the base 12 in order to avoid eddies in the inlet or outlet housings 14, 18, respectively. The filter elements 32 are shaped to maximize the surface area within the inlet housing 14 while optimizing the flow through the openings 30. As the number of filter elements 32 increase the area of openings 30 decrease, but using more filter elements 32 can increase the filter area—so it becomes a trade-off. It is believed that about 12 filter elements 32 is the most that are likely to be used in current air boxes 10, but the number could increase for special applications in large vehicles, so more than 12 are believed possible.

The filter elements 32 are located to increase the air flow through the air box 10 but preferably located to achieve equal or fairly equal flow through each filter element. If the air inlet opening 16 is located above the filter elements 32 then the inlet opening is preferably centered on the arrangement of filter elements 32 so the air flow through the filter elements 32 and openings 30 is more along the longitudinal axis of each filter element. In the axial flow orientation case the caps 34 are selected to direct the flow smoothly around the filter while reducing drag so the rounded, pointed or domed caps are preferred over the flat caps. When the air flow inlet 16 is on the side of the filter elements the inlet is preferably arranged along a central flow channel through the filter elements 32 opening. If the air flow from inlet 16 to base openings 30 causes air to flow more directly toward the side of the filter elements or laterally, rather than along the longitudinal axis, then the filter elements are arranged to facilitate flow and reduce drag while increasing the filter area. That usually means the caps 34 are flat or only slightly domed. Of course the filter height and shape and size affect the air flow, and the configuration of the inlet housing 14 may affect those filter parameters. Thus, the arrangement of filter elements 32 and caps 34 will vary. This is especially so when the filter elements 32 are used to create a replacement filter for a preexisting air box 10. But the use of multiple filter elements 32 is believed able to increase the filter area of such preexisting air boxes while maintain adequate flow.

Referring to FIGS. 1 and 2a-2c, the bottom portions of the filter elements 32 are typically bonded into place by liquid adhesive or melted elastomer which sets or hardens to hold the filter element in place and seal the bottom of the filter element against the passage of air. As illustrated in FIGS. 2a-2c, the end of the filter element 32 may abut the base plate 12 (FIG. 2a), or more advantageously the bottom portion of the filter element 32 may dipped in a heated elastomer and placed in annular recess 40 of diverse shapes (FIGS. 2b, 2c) where the elastomer sets and solidifies as it cools to bond the filter element to the base 12 and to prevent air from passing between the bottom portion of the filter element and the base 12. Likewise, the cap 34 is typically bonded to the upper end of the filter element with an adhesive or melted elastomer which sets or hardens to hold the filter element 32 to the cap and to prevent the passage of air between the upper portion of the filter element and the cap.

The configuration of the juncture of the bottom portion of filter elements 32 with the base plate 12 and the openings 30 may be configured to affect the air flow through and filter element. Referring to FIGS. 2a-2c, the base plate 12 may be formed with an annular recess 40 in the inlet side of base 12, encircling each opening 30. The shape of upper and lower surfaces of the base plate 12 forming the openings 30 and the connection with the base of the filter elements 32 may vary and are preferably configured to improve the flow of air through the filter elements 32 and through the openings 30 and through the housing 14. Whether the optimum air flow is achieved by a flattened area 42 surrounding the inside of the filter element 32 with rounded edges on the inlet side of opening 30 (FIG. 2a, 2c) or if optimum flow is achieved by a more shaped and contoured inlet 42 (FIG. 2b) will vary with the particular circumstances of each filter and housing assembly. Likewise the outlet edge 44 of the opening 30 on the outlet side of the base plate 12 may be rounded to improve air flow and reduce pressure drop as the air exits the opening 30.

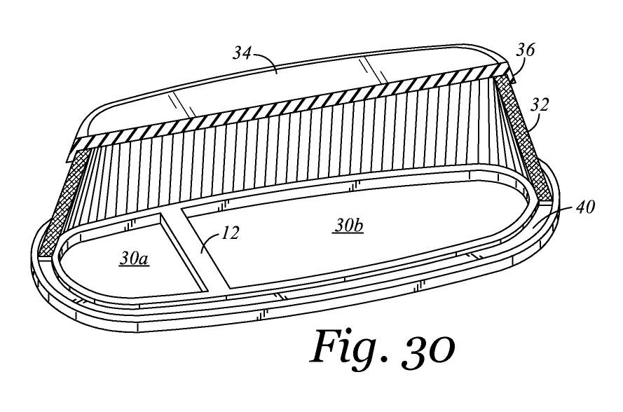

The openings 30 may vary in size and shape and each opening 30 is associated with a different one of the filter element 32, preferably having a size and shape corresponding to, but slightly smaller than, the open bottom of the filter element. Referring to FIG. 30, it is believed possible, but less desirable to have base plate structure extending across more than one of the openings 30, so as to create a cross-braces or a plurality of aligned circular holes encompassed within the base of one filter element 32, in order to strengthen the base plate 12 while increasing the air flow air flow through the opening 30. But preferably, every opening 30 extending through the base plate 12 preferably has only one filter element 32 associated with the opening so that no unfiltered air passes across the base plate 12.

In use, the filter elements 32 are sealingly connected to the base plate 12 and the plate is fastened to the inlet housing 14, fastened to the outlet housing 18, or fastened between the inlet and outlet housings 14, 18. A shaped ledge or lip 46 may be provided on the outer periphery of the base plate 12 to mate with a correspondingly shaped edge on the periphery of the inlet housing 14 and/or outlet housing 18. The base plate 12 may be permanently bonded to the housings 14, 18 with an adhesive or hot elastomer that sets and bonds as it cools, or with any other permanent fastening mechanism, such as melting, vibratory welding, etc. Or the base plate 12 may be removably fastened between the housings 14, 18 with threaded fasteners, over-center clamps, or any other removable connector. The air enters the air inlet 16, passes through the filter elements 32 and openings 30 in the base plate, and flows out the outlet opening 20.

There is also provided a method of forming a base plate for an air box, and of forming an improved air box. A base plate is formed with a plurality of openings 30 therethrough by any suitable method. The base plate may be of molded plastic, such as PVC, urethane, silicone, rubber or other suitable elastomer, with the openings 30 integrally formed when the base plate is formed. If base plate 12 is of metal the openings 30 may be cut, stamped or formed by any suitable method. As desired, annular recesses 40 may be formed around the periphery of one or more openings 30 at the time the openings are formed, as by molding simultaneously with the openings 30, routing, cutting or any other means available. Each filter element 32 is selected to have an open bottom large enough to fit around the selected opening 30 associated with the filter element and the bottom is then sealed around the selected opening 30 to fasten the filter element to the base plate 12. The cap 34 is likewise sealably fastened to the open top of the filter element and may be fastened before or after the filter element is fastened to the base plate 12. The base plate 12 with filter elements 32 and caps 34 is then connected to either or both of the inlet housing 14 and outlet housing 18.

Before being connected to the base plate 12, the filter elements 32 and caps 34 are selected so that the filter elements and caps will fit within the inlet housing 14, preferably without the caps 34 abutting the inlet housing 14. It is believed possible, but less desirable, to have one or more caps 34 abut the inside of the inlet housing 14, and if so it may be advantageous to have a recessed portion or depending flange configured to mate with and engage the outer periphery of the cap 34 to hold the cap and inlet housing from large relative motions during use. Preferably though, the cap 34 does not abut the inside of inlet housing 14 and instead the caps 34 and the exterior shape of the filter elements are configured to achieve a desired air flow pattern through the plurality of filter elements 32.

In the above descriptions the filter elements 32 and caps 34 are shown as being different in one of height, diameter, shape or cap shape, but the filter elements 32 could be the same and the caps 34 may be the same.

The above description is given by way of example, and not limitation. Given the above disclosure, one skilled in the art could devise variations that are within the scope and spirit of the invention disclosed herein, including various ways of arranging and shaping the filter elements 32 and caps 34. Further, the various features of the embodiments disclosed herein can be used alone, or in varying combinations with each other and are not intended to be limited to the specific combination described herein. Thus, the scope of the claims is not to be limited by the illustrated embodiments.

What is claimed is:

1. An assembly for use with an air filter box having an inlet housing with an air inlet, an outlet housing with an air outlet, and a base plate separating the inlet and outlet housing, comprising:
a base plate having a plurality of opening extending therethrough, the plate having an inlet side and an opposing outlet side, the plate having a periphery configured to mate with at least one of the inlet housing or outlet housing;
at least two, tubular air permeable filter elements located on the intake side of the base plate and extending away from that intake side of the base plate, the at least two filter elements each having an open bottom end that is sealingly connected to the base plate, the at least two filter elements each having at least a portion of the filter element encircling a different one of said openings associated with the filter element, the at least two of the filter elements each having an open top extending away from the base plate sufficient to define a height which height is not great enough so the filter element contacts a portion of the air inlet housing during use;
each filter element having a cap sealingly connected to the open top end of the filter element to close the open top; and
wherein the at least two filter elements differ from each other in at least one of a filter shape, the filter height, an opening size associated with the filter, and opening shape associated with the filter, the filter elements being configured and located to fit within the inlet housing during use.

2. The filter assembly of claim 1, wherein the filter elements differ by the shape of the caps.

3. The filter assembly of claim 1, wherein the filter elements differ by the shape of the filters.

4. The filter assembly of claim 1, wherein the filter elements differ by the shape openings through the base plate.

5. The filter assembly of claim 1, wherein the filter elements differ by size of the openings through the base plate.

6. The filter assembly of claim 1, wherein the filter elements include conical filters of different height.

7. The filter assembly of claim 1, wherein the filter elements include conical filters of different diameter and height.

8. The filter assembly of claim 1, wherein the base plate has a plurality of the openings on inlet or outlet sides of the base plate are contoured to increase air flow or to reduce drag.

9. The filter assembly claim 1, wherein there are from 3-6 filter elements.

10. The filter assembly of claim 9, wherein the filter elements differ by the shape of the caps.

11. The filter assembly of claim 9, wherein the filter elements differ by the shape of the filters.

12. The filter assembly of claim 9, wherein the filter elements differ by the shape openings through the base plate.

13. The filter assembly of claim 9, wherein the filter elements differ by size of the openings through the base plate.

14. The filter assembly of claim 9, wherein the filter elements include conical filters of different height.

15. The filter assembly of claim 9, wherein the filter elements include conical filters of different diameter and height.

16. The filter assembly of claim 1, wherein the base plate is connected to the inlet housing.

17. The filter assembly of claim 9, wherein the base plate is connected to the inlet housing

18. The filter assembly of claim 1, wherein the base plate is connected to the outlet housing.

19. The filter assembly of claim 9, wherein the base plate is connected to the outlet housing.

20. A method of assembling an air filter to a base plate having an air inlet side and an opposing air outlet side, the base plate and air filter for use in an air box having an inlet housing and an outlet housing, comprising:
acquiring a base plate having at least first and second openings extending therethrough and through which air flows during use of the air filter;
sealably connecting a bottom portion of a first air permeable filter element to the base so as to surround the first openings and sealably connecting a bottom portion of a second air permeable filter element to the base so as to surround the second opening, the first and second filter elements extending on the air inlet side of the base plate; and
sealably connecting a first cap to a top portion of the first air filter element and sealably connecting a second cap to a top portion of the second air filter element, the caps being sealably connected either before or after the bottom portions are sealably connected to the base plate;
wherein the first and second filter elements are selected to be different in at least one of a height, diameter, shape and cap shape and further selected so the filter elements fit between the base plate and the inlet housing when the base plate is fastened to the inlet housing for use.

21. The filter assembly of claim 20, further comprising fastening the base plate to the inlet housing with the filter elements located between the base plate and the inlet housing.

22. The filter assembly of claim 21, further comprising the step of fastening the base plate to the outlet housing.

23. The filter assembly of claim 21, wherein there are from 3-6 filter elements.

24. The filter assembly of claim 21, wherein there are from 3-6 filter elements, with each filter element being different.
